(19) United States
(12) Patent Application Publication
(10) Pub. No.: US 2026/0261627 A1
(43) Pub. Date: Sep. 3, 2026

(54) AUTO-PRESENT MODE FOR PRESENTATION APPLICATIONS

(71) Applicant: Microsoft Technology Licensing, LLC, Redmond, WA (US)

(72) Inventors: Priyankar KUMAR, New Delhi (IN); Ankit JAIN, Panchkula (IN); Sanjib BISWAS, New Delhi (IN); Abhishek AGARWAL, New Delhi (IN)

(21) Appl. No.: 19/066,733

(22) Filed: Feb. 28, 2025

(51) Int. Cl. H04N 7/15; G10L 13/08

(52) U.S. Cl. CPC H04N 7/15; G10L 13/08

(57) ABSTRACT

The techniques disclosed herein provide a system and method for automated presentation delivery utilizing artificial intelligence and speech processing technologies. The system processes presentation content, delivers it conversationally, and handles real-time audience interactions while maintaining contextual awareness. The disclosed systems enable dynamic presentation experiences by combining large language models with speech processing technologies to create an interactive presentation agent. Embodiments provide an Auto-Present mode in presentation applications that utilize Large Language Models powered AI agent to automatically present the content of a slide deck file, e.g., a PowerPoint file, just like how a human would, including audience interactions, slide navigations, live Question & Answer sessions and human-like narration of the slides.

### BACKGROUND

There are a number of presentation applications, such as PowerPoint or Google Slides, that allow users to organize and share content. Presentation applications utilize files that are in the form of a slide deck, where each page includes a combination of images, videos, and text. Presentation applications provide a number of features that allow users to display each slide in a sequence during an in-person meeting or online meeting.

Although presentation applications allow users to organize and share content in a slide deck, traditional presentation applications require manual advancement of slides and direct human delivery of the content. While speaker notes assist presenters, the presentation experience can be static and one-directional. Some presentation applications lack features that allow for a delivery of content while maintaining natural interaction with the audience.

In addition, although artificial intelligence (AI) models can be used to help generate presentation notes, presentation files are not formatted in a way that enables efficient interaction with AI models, including large language models. In view of the foregoing, there is an ongoing need to improve the feature set of presentation applications. In addition, there is an ongoing need to develop new methods for improving the way presentation files are used with AI models.

### SUMMARY OF THE INVENTION

The techniques disclosed herein provide a system and method for automated presentation delivery utilizing artificial intelligence and speech processing technologies. The system processes presentation content, delivers it conversationally to an audience, and handles real-time audience interactions while maintaining contextual awareness. The disclosed systems enable dynamic presentation experiences by combining large language models with speech processing technologies to create an interactive presentation agent. Embodiments provide an Auto-Present mode in presentation applications that utilize Large Language Models powered AI agent to automatically present the content of a slide deck file, e.g., a PowerPoint file, just like how a human would, including audience interactions, slide navigations, live Question & Answer sessions and human-like narration of the slides.

The disclosed techniques include a pre-process embodiment and an on-the-fly embodiment. The pre-process embodiment involves a process where an entire presentation file is communicated to a large language model (LLM), causing the LLM to generate a full presentation of the file contents. The on-the-fly embodiment involves a process where individual slides of a presentation file are communicated to an LLM, causing the LLM to generate a presentation for individual slides. This allows the LLM to adapt a presentation for subsequent slides based on the interactions captured during the presentation.

The present disclosure provides a number of tools. For instance, the system provides a slide navigation tool that allows the system to automatically navigate through the slides of a presentation file. This feature enables a system to advance a display of a slide to the next slide, navigate to a previous slide, or jump to a desired slide. The system also provides a mic tool that allows the system to automatically prompt for an audience response. The system can then control permissions for audience members allowing them to provide an input to the LLM, and causing the LLM to generate a customized presentation based on that input.

The disclosed techniques also provide enhanced training for AI models. Models can also be trained to generate presentations that have specific characteristics, such as a particular voice, tone, mood, pace, style, etc. This allows a system to generate presentations having characteristics that accommodate a particular audience, subject matter, or forum. This feature also allows a system to generate presentations that mimic a particular person's presentation style. For instance, a system may have different models that are trained individually for different types of audiences such as all-hands meetings, group meetings, or even small private meetings. This way a presentation can be tailored to accommodate each type of audience. A system may also have different models that are trained individually for different types of presentation topics. For example, models may be trained to accommodate sales presentations, engineering presentations, research presentations, etc. This way a presentation can be tailored to accommodate each type of topic.

In some configurations, the system can analyze a video of a person's behavior during a presentation and train a model based on that person's physical characteristics such as their voice, inflections in their voice, and speed in which they present material. This information can be sent as grounding data with a query to a model to train that model to create personalized presentations that replicate the style of that person.

The disclosed techniques also provide a practical application for improving security of existing systems. Generally described, by controlling permissions that allow and restrict communication of video and audio streams of individual users, improved security of sensitive information is provided. In some embodiments, the system can automatically restrict the microphone from allowing a user to communicate to a meeting or from providing input to the presentation engine. For instance, a person's microphone may only be allowed to communicate information to the AI model during a Q&A session or during certain time periods within a presentation such as a particular slide or a time period within a slide. This allows improved security by protecting meeting participants from providing any unwanted input to a meeting or an AI model.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for automated presentation delivery utilizing artificial intelligence and speech processing technologies, where an application on a client is configured to generate a query for an LLM.

FIG. 2 is a block diagram of another system for automated presentation delivery utilizing artificial intelligence and speech processing technologies, where a server is configured to generate a query for an LLM.

FIG. 3A shows the first stage of a process for a pre-processing embodiment where a presentation file is communicated to an LLM, causing the LLM to generate slide navigation control data and a text transcript for multiple sections of the presentation file.

FIG. 3B shows a stage of a process for a pre-processing embodiment where the system navigates to a first slide of a presentation file.

FIG. 3C shows a stage of a process for a pre-processing embodiment where the system prompts the audience for a response and processes a voice input from the audience.

FIG. 3D shows a stage of a process for a pre-processing embodiment where the system navigates to another slide of a presentation file.

FIG. 3E shows a stage of a process for a pre-processing embodiment where the system prompts the audience for a response from the second slide and processes a voice input from the audience.

FIG. 3F shows a stage of a process for a pre-processing embodiment where the system navigates to a third slide of a presentation file.

FIG. 3G shows a stage of a process for a pre-processing embodiment where the system prompts the audience for a response from the third slide and processes a voice input from the audience.

FIG. 4 shows an example of how a system configures permissions for certain users are established in timeslots based on an analysis of a presentation file.

FIG. 5A shows a stage of a process for an on-the-fly embodiment where a selected slide of a presentation file is communicated to an LLM, causing the LLM to generate slide navigation control data and a text transcript for the selected slide.

FIG. 5B shows a stage of a process for the on-the-fly embodiment where a selected slide is displayed while the text transcript for the selected slide is rendered through a text-to-voice engine.

FIG. 5C shows a stage of a process for the on-the-fly embodiment where the system prompts the audience for a response and processes a voice input from the audience.

FIG. 5D shows a stage of a process for the on-the-fly embodiment where the system generates navigation data and a text transcript a specific slide based on the voice input from the audience.

FIG. 5E shows a stage of a process for the on-the-fly embodiment where the system navigates to a specific slide based on the voice input from the audience.

FIG. 6 is a flow diagram showing aspects of a routine for implementing aspects of the disclosed techniques.

FIG. 7 is a diagram illustrating a distributed computing environment capable of implementing aspects of the techniques and technologies presented herein.

FIG. 8 is a computer architecture diagram illustrating a computing device architecture for a computing device capable of implementing aspects of the techniques and technologies presented herein.

### DETAILED DESCRIPTION

The techniques disclosed herein provide a system and method for automated presentation delivery utilizing artificial intelligence and speech processing technologies. The system processes presentation content, delivers it conversationally, and handles real-time audience interactions while maintaining contextual awareness. The disclosed systems enable dynamic presentation experiences by combining large language models with speech processing technologies to create an interactive presentation agent. The embodiments disclosed herein provide an Auto-Present mode in presentation applications that utilize Large Language Models to power AI agents to automatically present the content of a slide deck file, e.g., a PowerPoint file, just like how a human would, including audience interactions, slide navigations, live Question & Answer sessions and human-like narration of the slides.

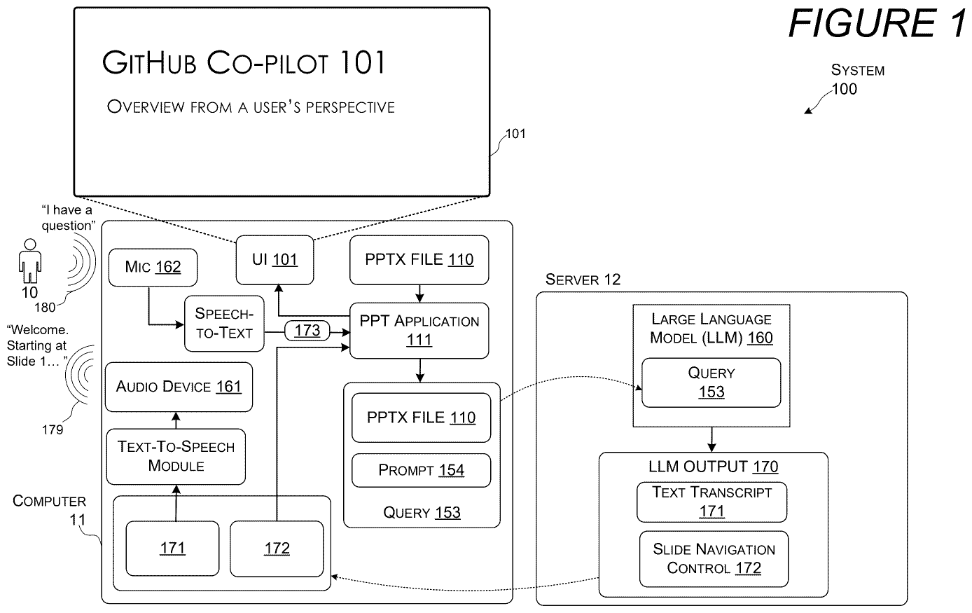

FIG. 1 illustrates a system 100 for providing automated presentation delivery utilizing artificial intelligence and speech processing technologies. In this example, the system 100 includes a computer 11 and a server 12. The system enables a presentation application 111 to utilize a large language model (LLM) 160 to present the contents of a presentation file 110 using a vocal output 179 and slide navigation controls 172 that controls which slide of the presentation file is displayed on a user interface 101. The presentation application 111 generates a query 153 comprising images, text, and speaker notes of the presentation file. This can be done by an on-the-fly approach or by a pre-processing approach. The on-the-fly approach means that the slides are individually provided to the LLM 160 allowing users to provide feedback during the presentation of each slide so that the presentation of subsequent slides is customized based on the audience input. The pre-processing approach allows the system to generate a full presentation by communicating the entire presentation file to the LLM.

The presentation application 111 generates a prompt 154 that instructs the large language model 160 to (1) generate a text transcript 171 describing the content of the presentation file, and (2) generate slide navigation controls 172 for controlling the display of individual slides within individual time periods. The slide navigation controls 172 can be a data file that defines timeslots for each slide, the order in which slides are presented, and instructions that cause the presentation application to control which slides are displayed while a text-to-speech module generates a voice output 179 for vocalizing associated sections of the transcript during presentation mode.

The system can then cause the communication of the query 153 to the large language model. The query causes the large language model to generate an LLM output 170 comprising the text transcript 171 describing at least one of the images and the text within the presentation file and the speaker notes. The query 153 further causes the large language model to generate slide navigation controls for controlling the display of individual slides within the individual time periods that are allocated for individual slides. The computer then receives the LLM output 170 comprising the text transcript 171 and the slide navigation controls 172.

Using the LLM output 170, the system causes the text-to-speech module to generate an audio output 179 having a speech output 179 of the contents of the text transcript 171. The system also uses the slide navigation controls 172 to cause the presentation application 111 to display individual slides of the presentation file according to the individual time periods allocated for each slide. The system can also receive a voice input 180 from the audience at a microphone 162, where the voice input 180 is converted to a text input 173 using a speech-to-text module. As described in more detail below, this text input 173 can be communicated to the LLM via subsequent queries for allowing the LLM to provide contextually relevant adjustments to the presentation.

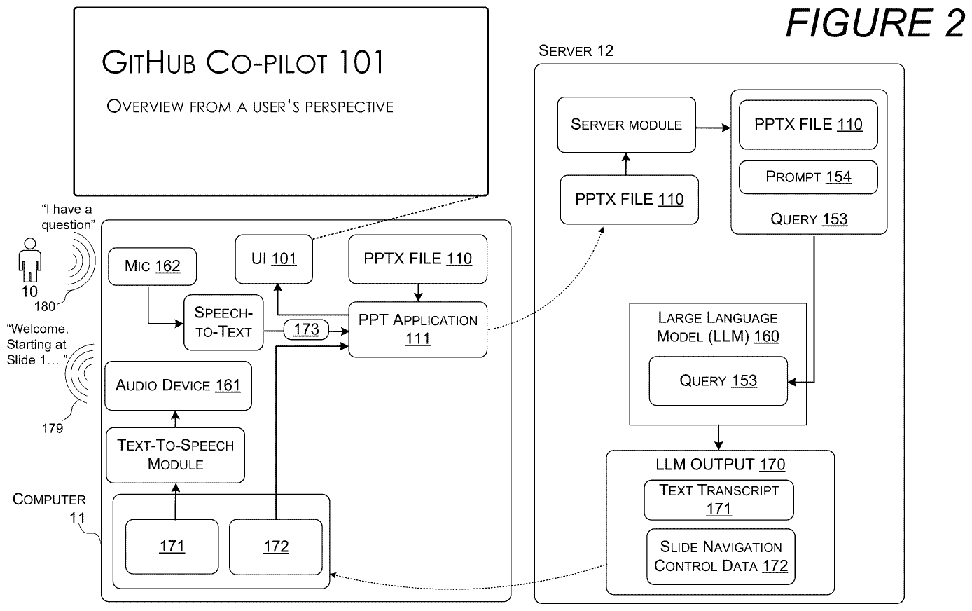

FIG. 2 shows another embodiment where the application sends the presentation file to the server and the server builds the query. In this embodiment, instead of having the presentation application generate the query, a server module generates the query in response to receiving the presentation file.

In some embodiments, the system utilizes a pre-processing approach. The application communicates the entire presentation file, including the images, speaker notes, and slide text, to the server. The server then sends file details to the LLM for processing. The LLM returns a JSON payload with a mapping of slide numbers and detailed slide summaries. The server caches the LLM-processed slides. Then, an auto-presentation mode can start when a user clicks on Auto-Present button in an application, such as PowerPoint.

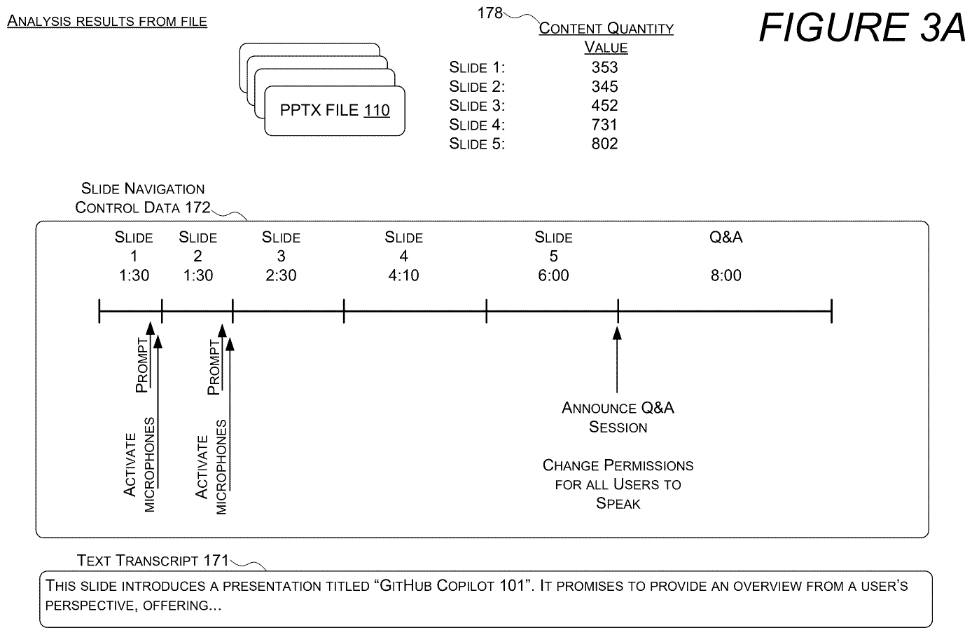

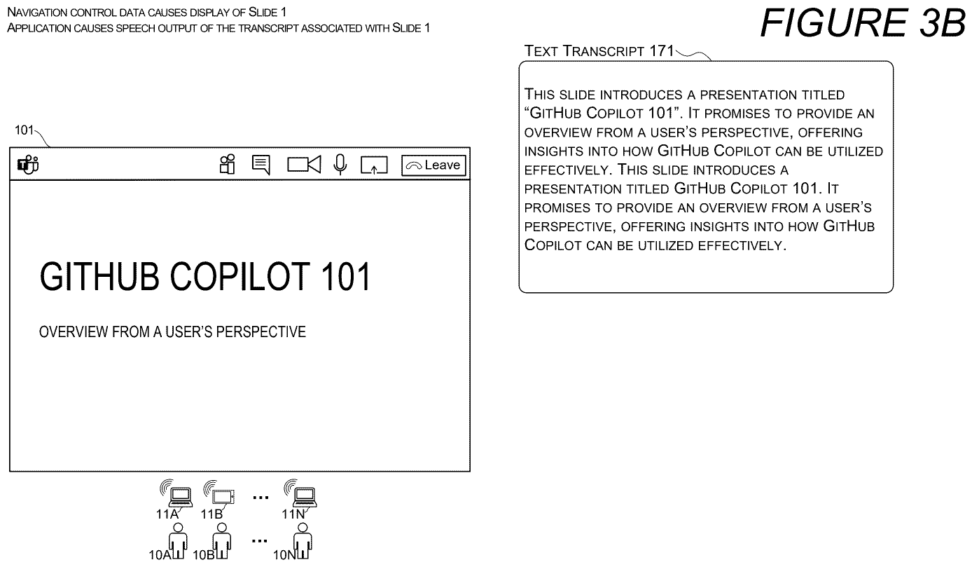

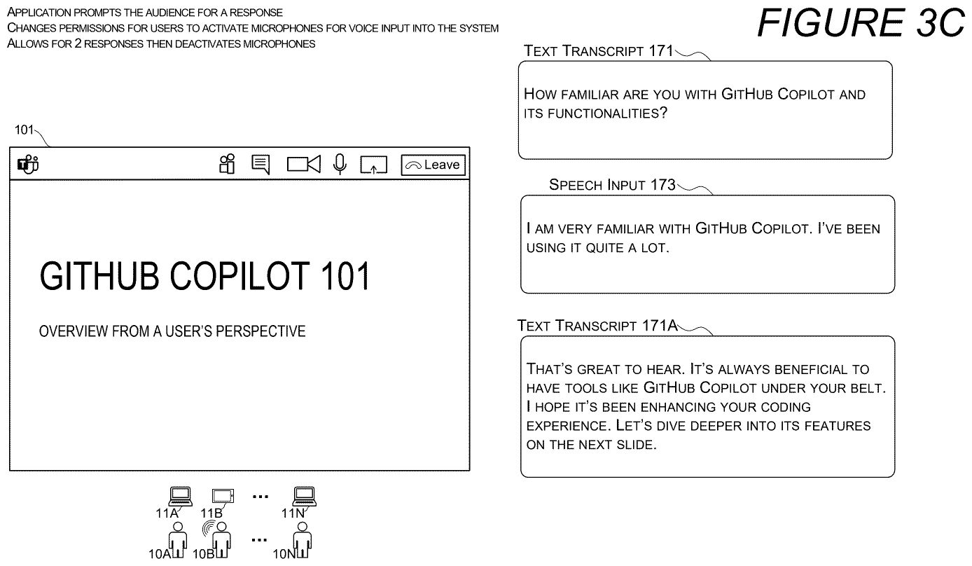

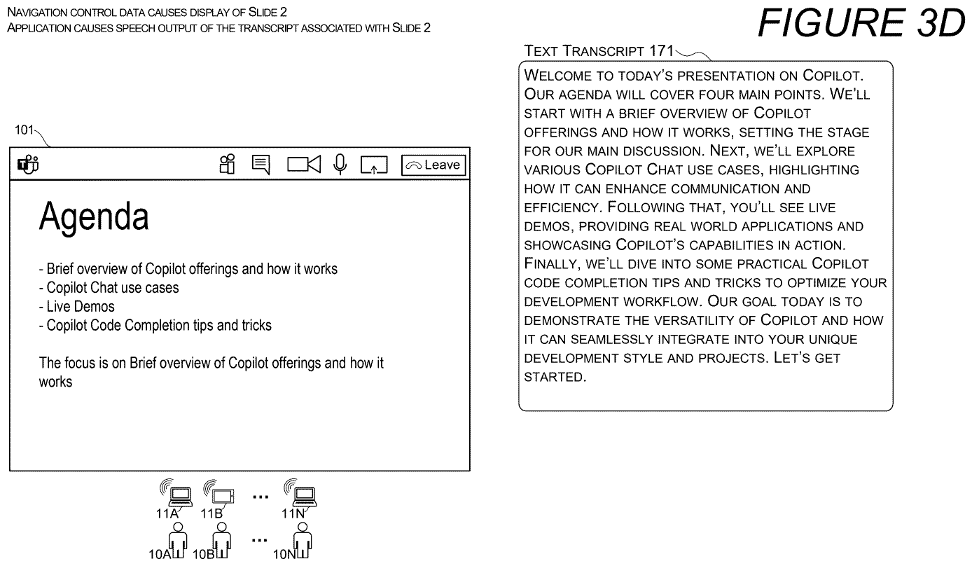

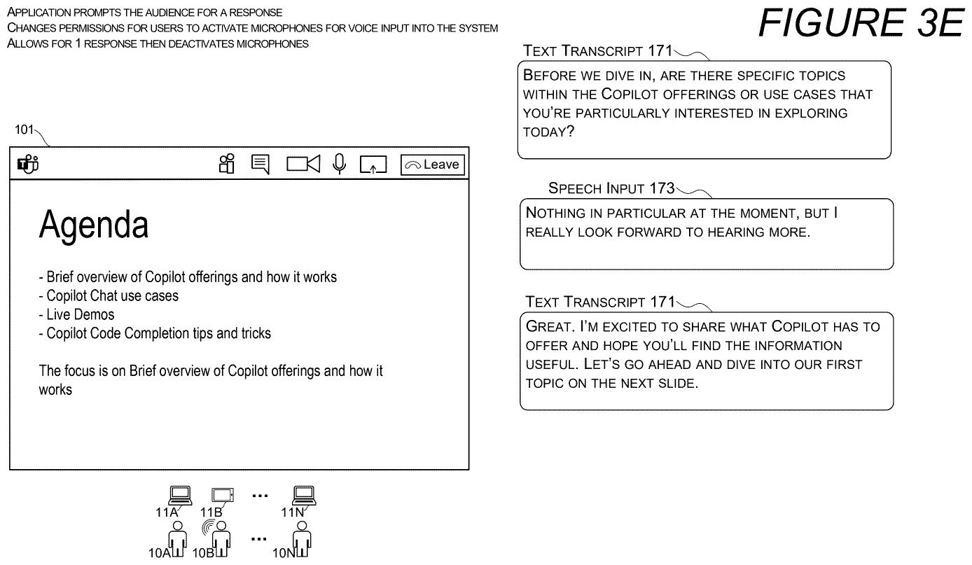

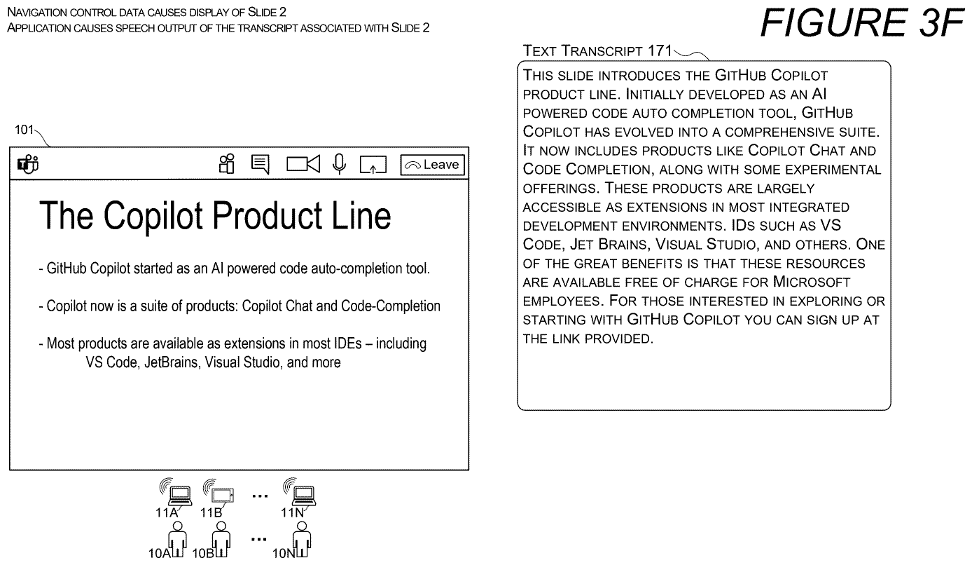

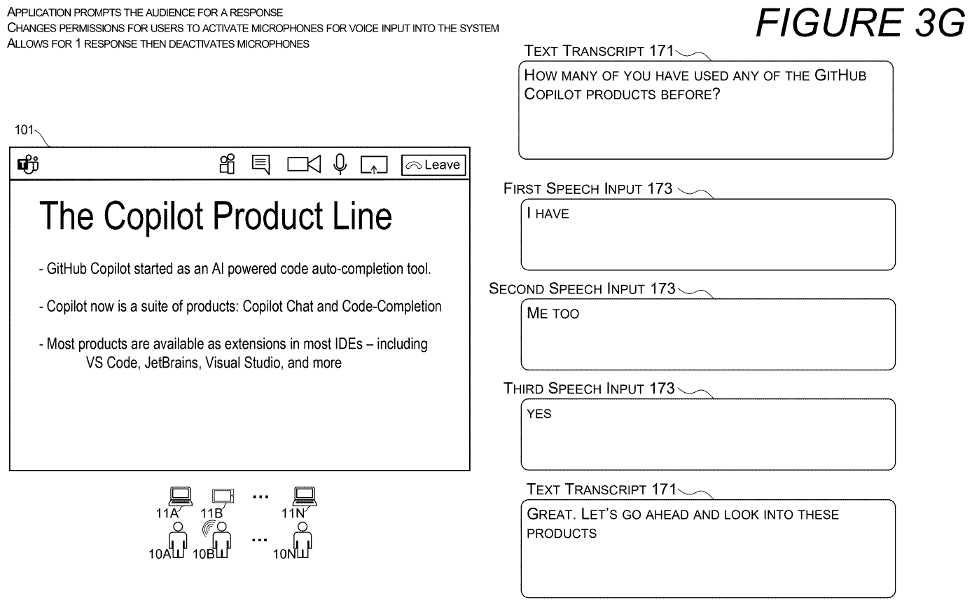

FIGS. 3A through 3G show an example of the pre-processing approach. FIG. 3A shows the first stage of a process for a pre-processing embodiment where a presentation file 110 is communicated to an LLM for causing the LLM to generate slide navigation control data 172 and a text transcript 171. In this example, a prompt is generated to cause the LLM to analyze the presentation file 110 and generate a text transcript 171 having sections of text that are associated with each slide of the presentation file. The text transcript can include a presentation-style narrative that introduces each slide and describes substantive points for each slide.

In addition to creating a text transcript for the presentation file, the prompt causes the LLM to analyze the content of each slide to determine a quantity value for the content of each slide. This quantity value can be based on one or more metrics of the text transcript, e.g., the length of the text transcript, length of the text in each slide, and/or a length of the presentation notes. The content quantity value is then used to determine the amount of time that is to be allocated to each slide. In this example, the times that are allocated for each slide are recorded in the slide navigation control data 172. The prompt is also configured to cause the LLM to determine a time at which each slide is to be transitioned.

The prompt is also configured to cause the LLM to determine times at which the presentation application prompts the audience. As shown in FIG. 3A, the LLM can generate control data that include prompt events at specific times. The prompt is also configured to cause the LLM to determine times at which the system activates microphones for the audience to allow them to speak. During those allocated time periods where the microphones are activate, the system is configured to receive a voice input from each audience member and that voice input is transcribed into text and provided as input to the LLM. As described below, the LLM is further configured to respond to the voice input. Once the slide navigation control data and the text transcript are generated, the system is ready for a user to initiate the presentation.

FIG. 3B shows a stage of a pre-processing embodiment where the system navigates to a first slide of a presentation file. The presentation can be initiated by a user input at the application. This example illustrates a presentation that is displayed to a number of users 10A-10N participating in an online meeting. Once initiated, the system utilizes the navigation control data and the text transcript to broadcast the presentation, where a voice output of the text transcript is generated at each of the client devices 11A-11N.

FIG. 3C shows a stage of a process for a pre-processing embodiment where the system prompts the audience for a response and processes a voice input from the audience. In this part of the process, using the navigation control data and the text transcript, the system can prompt the audience with a question, and then put the application in a wait state to allow each user to respond. In this example, one of the users provides a voice input response. The system then generates text from that voice input and communicates that text to the LLM, causing the LLM to generate another response in the form of additional a text transcript 171A.

FIG. 3D shows a stage of a process for the pre-processing embodiment where the system navigates to the second slide of a presentation file. The system displays the second slide according to the allocated time defined in the slide navigation control data, and the text transcript for the second slide is also sent to the text-to-speech module for generating a voice output at each computer.

FIG. 3E shows another iteration of the process where the system prompts the user for a voice input and another the reaction to that voice input is generated. Then, as shown in FIGS. 3F and 3G, the system continues through other slides of the presentation file, presenting each slide and prompting the audience according to the slide navigation control data.

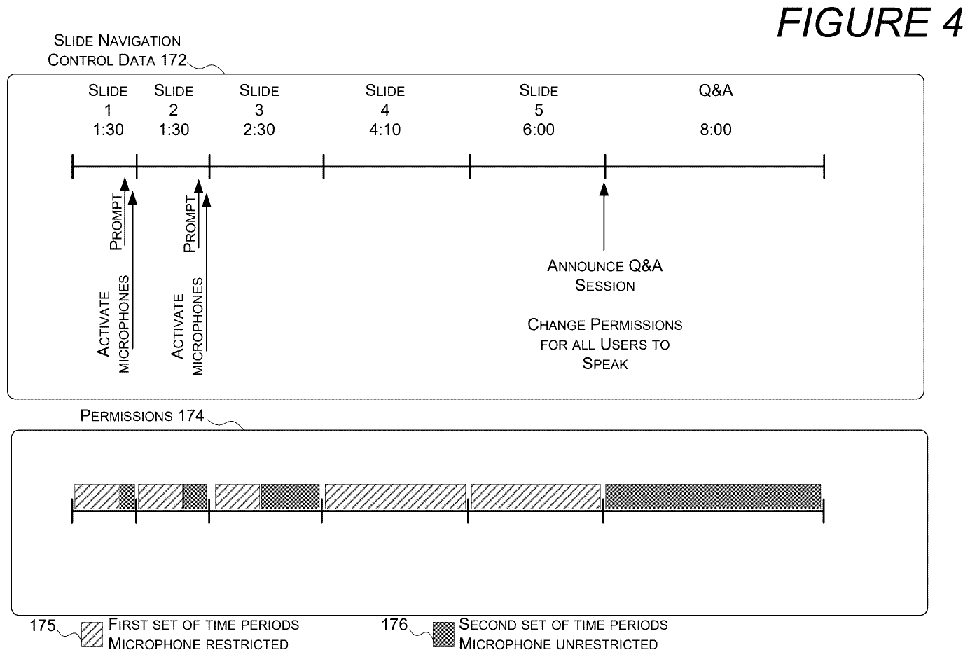

In some configurations, the system can configure permissions that restrict users from providing a voice input to the LLM and/or from providing voice input to the meeting. The system can also configure permissions that allow each audience member to provide a voice input to the LLM and to provide voice input to a meeting based on allocated time slots. FIG. 4 shows one example where permissions are generated for users based on an analysis of a presentation file. During a first set of time periods 175, the system restricts an audience voice input from being communicated to the LLM and/or restricts the audience voice input from being communicated to other participants of the meeting. In addition, during a second set of time periods 176, the system allows the audience to provide a voice input to the LLM and/or to the other participants of the meeting. These permissions can be established to control the flow of a presentation while also improving the effectiveness of interactions of the participants by allowing each person to speak at certain times. These permissions also improve the security of this system by preventing unwanted discussions from being communicated to the LLM and to other meeting participants.

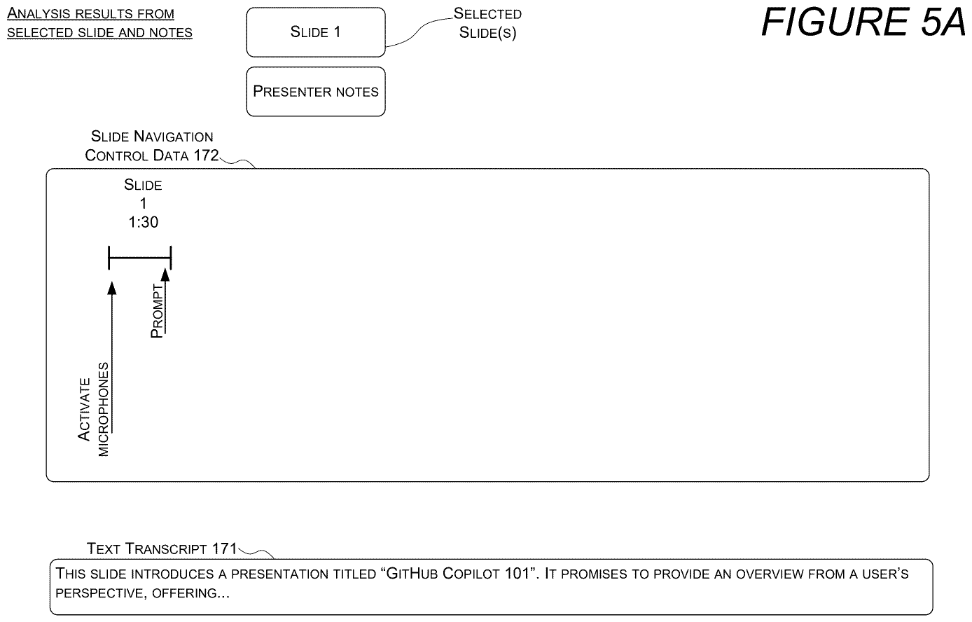

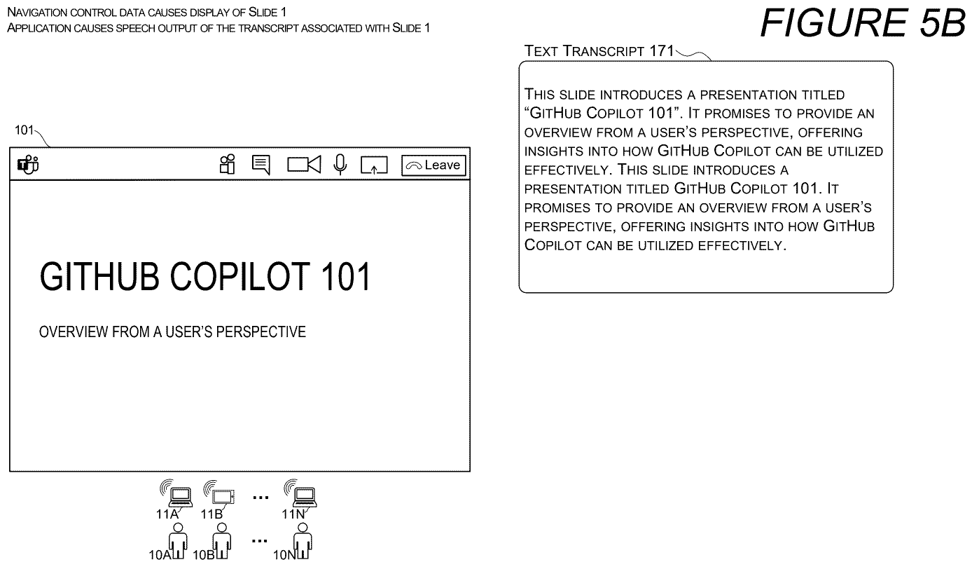

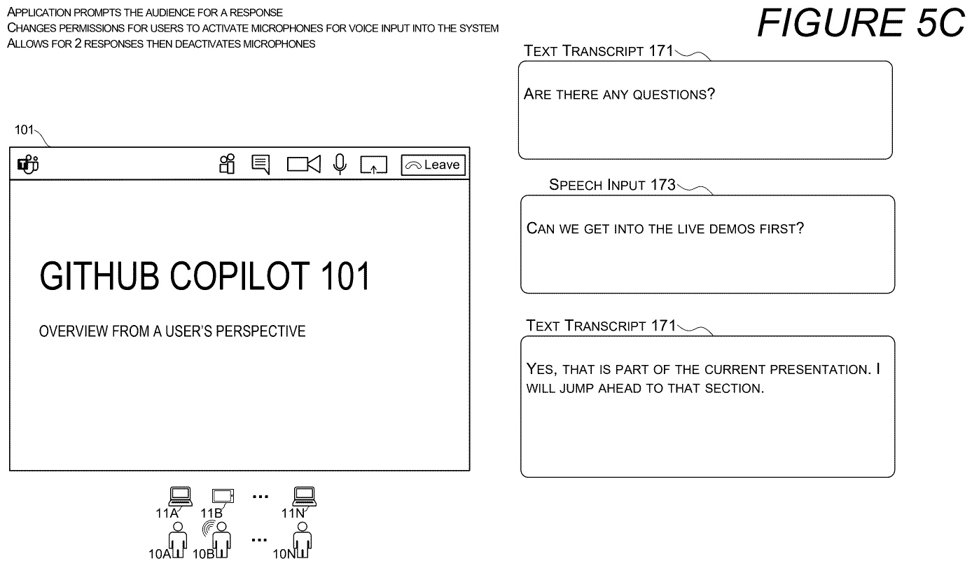

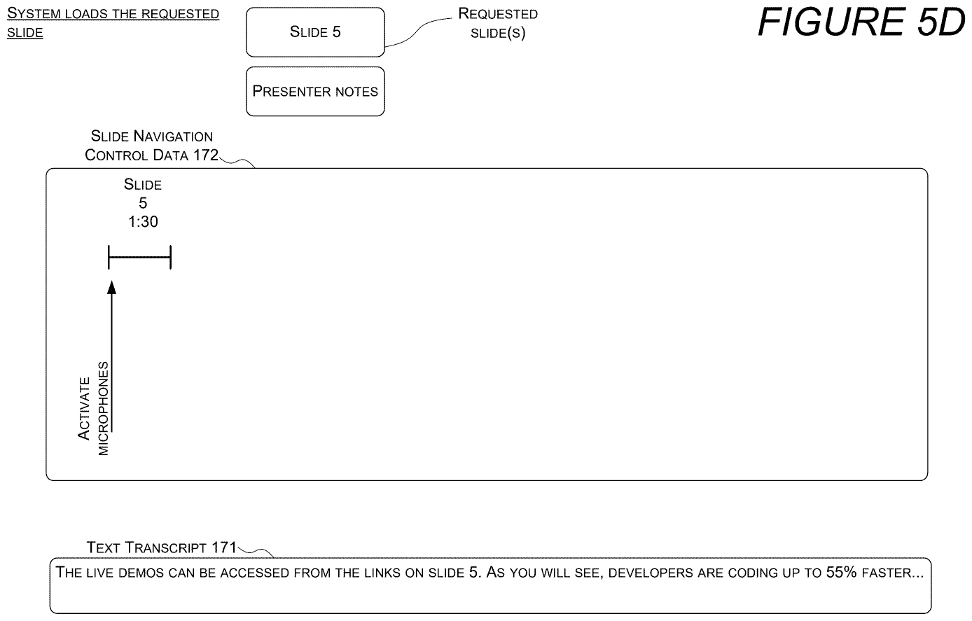

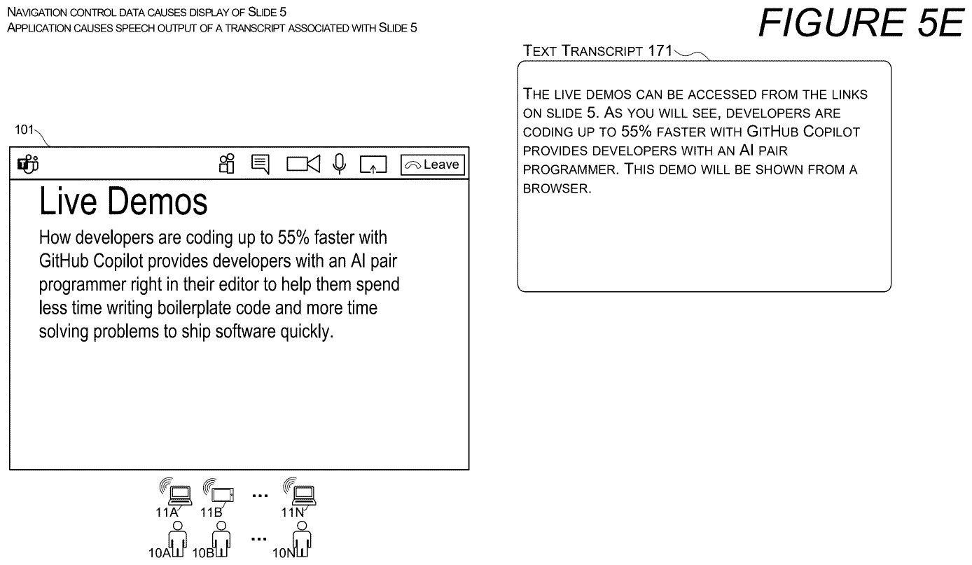

FIGS. 5A through 5E show an example of the on-the-fly approach. The on-the-fly embodiment involves a process where individual slides of a presentation file are communicated to an LLM, causing the LLM to generate a presentation for individual slides. This allows the LLM to adapt a presentation for subsequent slides based on the interactions captured during the presentation of the first slide.

In the on-the-fly embodiment, instead of using a time-based control that determines when a slide is displayed to the audience, the system can make decisions on the fly, where the model decides to invoke the slide navigation tool as the model completes a voice output for a transcript for a slide. The same control can be done for the mic controls.

For example, the system can run a loop that starts by receiving a first slide of a presentation file with other contextual information such as presenter notes. The system generates a transcript for that first slide and also produces an output that instructs the slide navigation control tool to display the first slide to the meeting participants.

The process continues where the system invokes a voice output for a transcript for a slide. During the voice output for a first slide, the system can gather information from the meeting and use that gathered information to make a decision of what slide to display next. The system can gather information such as the chat text, voice inputs from various users, shared files and other contextual information, which may include reactions and gestures performed by the users.

The collected information is provided to the large language model with a prompt that causes the large language model to produce output that controls the slide navigation tool to navigate to a different slide. For example, if people discussed a topic that is in a slide that is at the end of the deck, the system can generate an output that controls the slide navigation tool to navigate to that desired slide.

The output generated by the large language model can cause the slide navigation control tool to navigate to any desire slide. This can include advancing to the next slide, reverting back to a previous slide, or jumping to a particular slide. The system also generates a text transcript for the selected slide, and generate a voice output for that transcript to be used as an output on the computers of each user.

In such embodiments, the system runs a continuous loop with the system continually collect information while a text transcript is played for each displayed slide and then uses that gathered information to determine which slide to display next after the audio output of each transcript has been played. The system can also be configured to detect interruptions where the system momentarily stops the voice output of a text transcript to allow the system to determine which slide to display.

FIG. 5A shows a stage of a process for an on-the-fly embodiment where a selected slide of a presentation file is communicated to an LLM, causing the LLM to generate slide navigation control data 172 and a text transcript 171 for the selected slide. In this example, the prompt is generated for causing the LLM to analyze a selected slide, e.g., Side 1, and generate a text transcript 171 that describes the selected slide. The text transcript can include a presentation-style narrative that introduces the selected slide and describes substantive points of the selected slide.

In addition to creating a text transcript for the presentation file, the system can analyze the content that pertains to the selected slide and determine a content quantity value for the selected slide. This content quantity value can be based on the amount of content included in selected slide, including presentation notes and text within the selected slide, and also the text transcript generated for the selected slide. The content quantity value is then used to determine the amount of time that is to be allocated to the selected slide. In this example, the allocated time for the selected slide is recorded in the slide navigation control data 172.

The prompt is also configured to cause the LLM to receive voice input from the audience at select times. This allows for an interactive presentation where the text transcript is configured to prompt the audience, and then set configurations to activate microphones for the audience to allow them to speak. During those allocated time periods where the microphones are activated, the system is configured to receive a voice input from each audience member and that voice input is transcribed into text and provided as input to the LLM. The prompt is also configured to cause the LLM to properly respond to each text input which may include a text narrative responsive to the voice input. Once the slide navigation control data and the text transcript are generated, the system is ready for a user to initiate the presentation.

FIG. 5B shows a stage of a process for the on-the-fly embodiment where the system navigates to the selected slide of the presentation file. The presentation can be initiated by a user input at the application. This example illustrates a presentation that is displayed to a number of users 10A-10N participating in an online meeting. Once initiated, the system utilizes the navigation control data and the text transcript to run the presentation.

FIG. 5C shows a stage of a process for a pre-processing embodiment where the system prompts the audience for a response and processes a voice input from the audience. In this stage of the process, using the navigation control data and the text transcript, the system can prompt the audience with a question, and then put the application in a wait state to allow each user to respond. In this example, one of the users provides a voice input response. The system then generates text from that voice input and communicates that text to the LLM, causing the LLM to generate another response in the form of additional a text transcript 171A.

Also in this example, the voice input provided by the user indicates that they are interested in a particular topic, e.g., live demos. Based on this response, the system determines which slide pertains to the desired topic, and the system generates navigation control data to cause the application to display that slide. In addition, the system generates a text transcript pertaining to the topics provided in slide 5.

In this example, the prompt is configured to cause the LLM to receive voice input from the audience at select times. This allows for an interactive presentation where the text transcript and the slide navigation control data are configured to prompt the audience for an audience response, and set configurations to activate microphones for the audience to allow them to speak. During those allocated time periods where the microphones are activated, the system is configured to receive a voice input from each audience member and that voice input is transcribed into text and provided as input to the LLM. In addition, the prompt is configured for causing the LLM to properly respond to each text input with relevant narrative. The prompt may also be configured to cause the LLM to modify the order of the slides in the slide navigation control data. For instance, if an audience member has a question about a particular topic that pertains to slide 5, as shown in FIG. 5E, the system may generate a transcript indicating that the presentation will cover the requested topic and also generate navigation control data to cause the system to display slide 5.

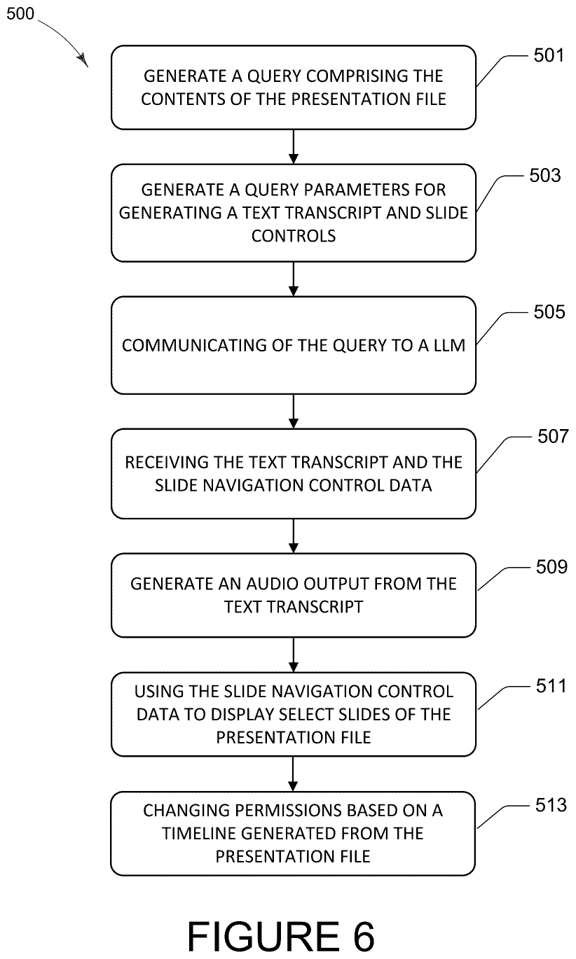

Turning now to FIG. 6, the following section describes aspects of a routine 500 for providing automated presentation delivery utilizing artificial intelligence and speech processing technologies is shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following description refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 500 starts at operation 501 where the system causes the generation of a query comprising the contents of the presentation file. This can include the entire presentation file, a selection of a set of slides or an individual slide from the presentation file.

At operation 503, the system generates a prompt for causing the LLM to generate a text transcript and slide control data. This causes an LLM to generate the control data that enables the presentation program to display desired slides that match the text transcript.

At operation 505, the system communicates the query to the LLM. This could involve sending the query to an LLM at the local computer or an LLM at a server.

At operation 507, the system can receive the text transcript and the slide navigation control data from the LLM.

At operation 509, the system generates an audio output from the text transcript. The text-to-speech conversion can be done at the server or at the client device.

At operation 511, the system uses the slide navigation control data to display select slides of the presentation file. This can include a display of a particular side for period of time, or a series of slides displayed according to time allocations defined by the navigation control data. At operation 512, the system also changes permissions based on a timeline generated from the presentation file.

The disclosed techniques also provide enhanced training for AI models. Models can also be trained to generate presentations that have specific characteristics, such as a particular voice, tone, mood, pace, style, etc. This allows a system to generate presentations having characteristics that accommodate a particular audience, subject matter, or forum. This feature also allows a system to generate presentations that mimic a particular person's presentation style. For instance, a system may have different models that are trained individually for different types of audiences such as all-hands meetings, group meetings, or even small private meetings. This way a presentation can be tailored to accommodate each type of audience. A system may also have different models that are trained individually for different types of presentation topics. For example, models may be trained to accommodate sales presentations, engineering presentations, research presentations, etc. This way a presentation can be tailored to accommodate each type of topic.

In some configurations, the system can analyze a video of a person's behavior during a presentation and train a model based on that person's physical characteristics such as their voice, inflections in their voice, and speed in which they present material. This information can be sent as grounding data with a query to a model to train that model to create personalized presentations that replicate the style of that person.

The above-described embodiments can include operations for communicating a recording of a presentation with transcripts of the recorded presentation, and a training presentation file having slides used for the recorded presentation as an input to the LLM. The system can then generate additional queries parameters for causing the LLM to fine-tune weights that enable the LLM to generate an output transcript having at least one of a language style that emulates the training presentation file, wherein the additional queries parameters further cause the LLM to fine-tune the weights that enable the LLM to generate the slide navigation data that emulates timing of slide transitions performed in the training presentation file. Then, the system can use the fine-tuned weights to generate subsequent text transcripts and subsequent instances of slide navigation control data based on subsequent presentation files received by the LLM.

Although the examples described herein include the speech-to-text module and the text-to-speech module as part of the client, it can be appreciated that these modules can be located on the server. These modules can also be part of the AI model, which can include being part of the LLM. These modules can also be part of a services that is separate from the server and client. In some embodiments, the system can also utilize audio-to-audio models, where audio files or audio streams are communicated to the model with a prompt for causing the models to generate the responses described herein.

Although the examples described herein refer to the use of a large language model, the techniques disclosed herein can utilize any combination of suitable Natural Language Processing (NLP) algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system.

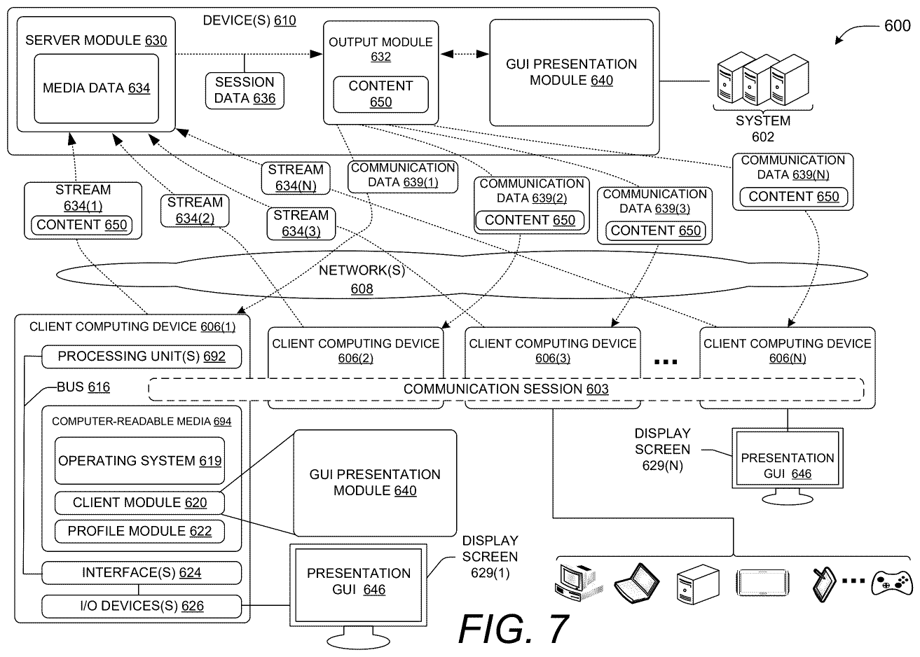

Turning now to FIG. 7, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 7 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 7 illustrates that client computing device 606(1) is in some way connected to a display device (e.g., a display screen 629(N)), which can display a UI according to the techniques described herein.

In the example environment 600 of FIG. 7, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 7) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 7, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

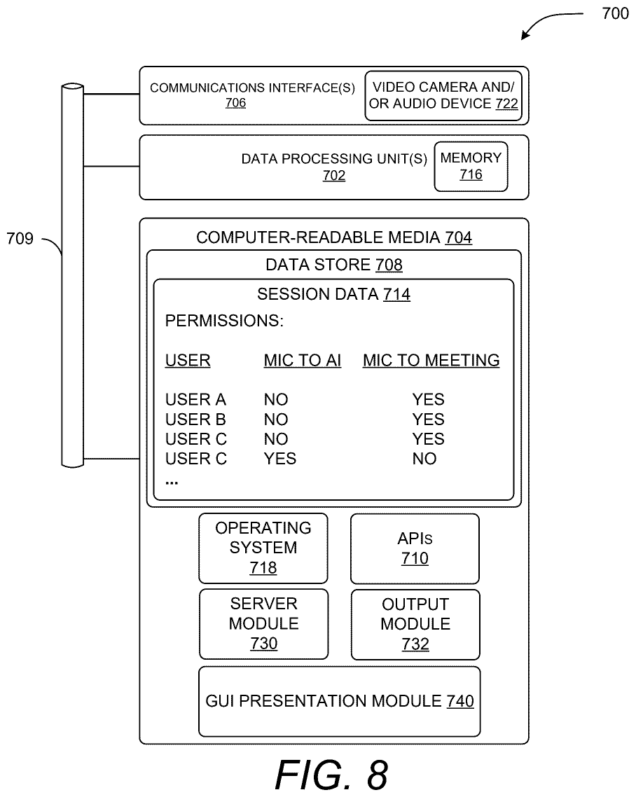

FIG. 8 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which is also referred to herein as computer-readable storage media, a computer-readable medium, or computer-readable storage medium, includes one or more of volatile memory, nonvolatile memory, and/or other persistent and/or auxiliary computer storage media, rotating storage medium such as a disk, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

A “computer-readable storage device” or a “computer-readable device” includes non-transitory computer-readable storage media such as one or more of volatile memory, nonvolatile memory implemented in any method or technology for storage of information such as computer-readable instructions, data structures, program modules, or other data. Thus, a computer-readable storage device includes tangible and/or physical forms of a hardware component that is part of a computing system or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), or flash memory, solid-state memory devices, storage arrays, network attached storage, storage area networks. The computer-readable storage device also includes a physical hardware device having circuitry and magnetic sensors, optical sensors, or other sensors for reading a compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, or any other physical locally stored medium that can be used to store and maintain information for access by a computing device.

In contrast to computer storage media or a computer-readable storage medium, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include permission data 714. The permission data 714 defines restrictions for specific users and their associated computers from communicating audio and text to an LLM. This means that those users cannot provide input to an LLM to instruct the LLM to generate a response during time periods where the restriction is active. The permission data 714 also defines restrictions for specific users and their associated computers from communicating audio and text to a meeting. This means that those users cannot provide input that is transmitted to other users of a meeting during time periods where the restriction is active. The permissions can allow the users and their associated devices to communicate audio streams and text to the LLM and the meeting during specified periods of time.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

The following clauses supplement the present disclosure:

Clause A: A method for enabling a presentation application (111) to utilize a large language model (160) to present the contents of a presentation file (110) using a vocal output (179) and slide navigation control data (172), the method for execution on a system (100), the method comprising: communicating at least a portion of the PPTX file to the LLM, which includes causing the presentation application (111) to generate a query comprising at least one of images and text within the presentation file (110) and speaker notes, generating query for the LLM, e.g., causing the presentation application (111) to generate a prompt (154) that is configured to cause the large language model (160) to: generate a text transcript (171) describing at least one of the images and the text within the presentation file and the speaker notes, e.g., LLM generates narrative, generate the slide navigation control data (172) for controlling the display of individual slides within individual time periods; depending on time and order, e.g., LLM generates data for navigating the slides; communicating of the query (153) to the large language model causing the large language model to generate an LLM output (170) comprising the text transcript (171) describing at least one of the images and the text within the presentation file and the speaker notes, the query (153) further causing the large language model to generate slide navigation control data (172)for controlling the display of individual slides within the individual time periods that are allocated for individual slides; receiving the LLM output (170) comprising the text transcript (171) and the slide navigation control data (172); generating a speech output using the LLM output, e.g., using the LLM output (170) to cause a text-to-speech to generate an audio output (179) having a speech output (179) of the contents of the text transcript (171); controlling the display of each slide based on allocated time periods, using the slide navigation control data (172) of the LLM output (170) to cause the presentation application (111) to display the slides of the presentation file according to the individual time periods allocated for individual slides while generating the vocal output (179) using content from the text transcript (171).

Clause B: The method of Clause A, wherein the query includes the entire presentation file (110), wherein the prompt (154) causes the LLM to configure the text transcript (171) to include a description of multiple sections of the presentation file (110), wherein the prompt (154) causes the LLM to configure the navigation control data (172) to allocate individual time periods for multiple slides, and wherein the display the slides of the presentation file is based on the individual time periods for the multiple slides, see FIGS. 3A-3G: pre-process embodiment: communicating the full PPT file to the LLM.

Clause C: The method of Clauses A and B, wherein the method includes configuring the prompt to cause the LLM to determine a first set of time periods (175) for restricting communication of audio streams that includes a vocal input from one or more users associated with one or more computing devices participating in an online meeting, wherein the restriction during the first set of time periods prevents audio streams (634) or text generated from the audio streams from being communicated as an input to the LLM and the restriction prevents audio streams (634) from being communicated between the computing devices (606) participating in the online meeting during the first set of time periods, wherein the prompt is configured to further cause the LLM to determine a second set of time periods (176) for allowing communication of audio streams that includes the vocal input from one or more users associated with one or more computing devices participating in an online meeting, wherein the permissions allowing the audio streams or the text generated from the audio streams to be communicated as the input to the LLM and the permissions allowing the audio streams to be communicated between the computing devices participating in the online meeting during the second set of time periods, wherein the method further comprises restricting, during the first set of time periods, communication of audio streams from the one or more computing devices to prevent the audio streams or text generated from the audio streams from being communicated as the input to the LLM; restricting, during the first set of time periods, communication of audio streams between the computing devices; allowing, during the second set of time periods, communication of audio streams from the one or more computing devices as the input to the LLM; and allowing, during the second set of time periods, the audio streams to be communicated between the computing devices participating in the online meeting.

Clause D: The method of Clauses A through C, wherein the query includes an individual slide or a select group of slides of the presentation file (110), wherein the prompt (154) causes the LLM to configure the text transcript (171) to include a description of an individual slide or a select group of slides of the presentation file (110), wherein the LLM further configures the text transcript to prompt one or more recipients of the vocal output (179) to provide a vocal input, wherein the prompt (154) causes the LLM to configure the navigation control data (172) to allocate an individual time period for the individual slide or the select group of slides, wherein the display the slides of the presentation file that is based on the individual time period for the individual slide or the select group of slides, wherein the method further comprises: generating a second query that causes the LLM to generate additional text transcript that responds to the vocal input, see FIGS. 5A-5E: on-the-fly embodiment: individual slides or select slides are communicated to the LLM.

Clause E: The method of Clauses A through D, wherein the query includes an individual slide or a select group of slides of the presentation file (110), wherein the prompt (154) causes the LLM to configure the text transcript (171) to include a description of an individual slide or a select group of slides of the presentation file (110), wherein the LLM further configures the text transcript to prompt one or more recipients of the vocal output (179) to provide a vocal input, wherein the prompt (154) causes the LLM to configure the navigation control data (172) to allocate an individual time period for the individual slide or the select group of slides, wherein the display the slides of the presentation file that is based on the individual time period for the individual slide or the select group of slides, wherein the method further comprises: generating a second query that includes text that is transcribed from the vocal input, and generating an additional prompt for causing the LLM to generate a second instance of the slide navigation control data for causing a display of a second slide or a second group of slides that are selected based on the vocal input, see FIGS. 5A-5E: on-the-fly embodiment, this claim is directed to features where the LLM navigates to a particular slide based on the voice input from the audience.

Clause F: The method of Clauses A through E, further comprising training the model by: communicating a recording of a presentation with transcripts of the recorded presentation, and a training presentation file having slides used for the recorded presentation as an input to the LLM; generating additional queries parameters for causing the LLM to fine-tune weights that enable the LLM to generate an output transcript having at least one of a language style that emulates the training presentation file, wherein the additional queries parameters further cause the LLM to fine-tune the weights that enable the LLM to generate the slide navigation data that emulates timing of slide transitions performed in the training presentation file; and using the fine-tuned weights to generate subsequent text transcripts and subsequent instances of slide navigation control data based on subsequent presentation files received by the LLM.

Clause G: The method of Clauses A through F, further comprising: parsing the presentation file into a plurality of components including images, text associated with the images, and presentation notes associated with the images, wherein query further comprises additional prompt that causes the LLM to associate the images, the text, and the presentation notes for individual slides and generate the text transcript for the individual slides, the additional prompt further causing the LLM to analyze the images, the text, and the presentation notes for individual slides to determine an order in which the slide are presented during playback of the presentation.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

We claim:

1. A method for enabling a presentation application to utilize a large language model to present the contents of a presentation file using a vocal output and slide navigation control data, the method for execution on a system, the method comprising:
causing the presentation application to generate a query comprising at least one of images and text within the presentation file and speaker notes,
causing the presentation application to generate a prompt that is configured to cause the large language model to:
generate a text transcript describing at least one of the images and the text within the presentation file and the speaker notes,
generate the slide navigation control data for controlling the display of individual slides within individual time periods; dep: time and order
communicating of the query to the large language model causing the large language model to generate an LLM output comprising the text transcript describing at least one of the images and the text within the presentation file and the speaker notes, the query further causing the large language model to generate slide navigation control data for controlling the display of individual slides within the individual time periods that are allocated for individual slides;
receiving the LLM output comprising the text transcript and the slide navigation control data;
using the LLM output to cause a text-to-speech to generate an audio output having a speech output of the contents of the text transcript;
using the slide navigation control data of the LLM output to cause the presentation application to display the slides of the presentation file according to the individual time periods allocated for individual slides while generating the vocal output using content from the text transcript.

2. The method of claim 1, wherein the query includes the entire presentation file, wherein the prompt causes the LLM to configure the text transcript to include a description of multiple sections of the presentation file,
wherein the prompt causes the LLM to configure the navigation control data to allocate individual time periods for multiple slides, and
wherein the display the slides of the presentation file is based on the individual time periods for the multiple slides.

3. The method of claim 1, further comprising:
configuring the prompt to cause the LLM to determine a first set of time periods for restricting communication of audio streams that includes a vocal input from one or more users associated with one or more computing devices participating in an online meeting, wherein the restriction during the first set of time periods prevents audio streams or text generated from the audio streams from being communicated as an input to the LLM and the restriction prevents audio streams from being communicated between the computing devices participating in the online meeting during the first set of time periods,
wherein the prompt is configured to further cause the LLM to determine a second set of time periods for allowing communication of audio streams that includes the vocal input from one or more users associated with one or more computing devices participating in an online meeting, wherein the permissions allowing the audio streams or the text generated from the audio streams to be communicated as the input to the LLM and the permissions allowing the audio streams to be communicated between the computing devices participating in the online meeting during the second set of time periods, wherein the method further comprises
restricting, during the first set of time periods, communication of audio streams from the one or more computing devices to prevent the audio streams or text generated from the audio streams from being communicated as the input to the LLM;
restricting, during the first set of time periods, communication of audio streams between the computing devices;
allowing, during the second set of time periods, communication of audio streams from the one or more computing devices as the input to the LLM; and
allowing, during the second set of time periods, the audio streams to be communicated between the computing devices participating in the online meeting.

4. The method of claim 1,
wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises: generating a second query that causes the LLM to generate additional text transcript that responds to the vocal input.

5. The method of claim 1,
wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises:
generating a second query that includes text that is transcribed from the vocal input, and
generating an additional prompt for causing the LLM to generate a second instance of the slide navigation control data for causing a display of a second slide or a second group of slides that are selected based on the vocal input.

6. The method of claim 1, further comprising:
communicating a recording of a presentation with transcripts of the recorded presentation, and a training presentation file having slides used for the recorded presentation as an input to the LLM;
generating additional queries parameters for causing the LLM to fine-tune weights that enable the LLM to generate an output transcript having at least one of a language style that emulates the training presentation file, wherein the additional queries parameters further cause the LLM to fine-tune the weights that enable the LLM to generate the slide navigation data that emulates timing of slide transitions performed in the training presentation file; and
using the fine-tuned weights to generate subsequent text transcripts and subsequent instances of slide navigation control data based on subsequent presentation files received by the LLM.

7. The method of claim 1, further comprising: parsing the presentation file into a plurality of components including images, text associated with the images, and presentation notes associated with the images, wherein query further comprises additional prompt that causes the LLM to associate the images, the text, and the presentation notes for individual slides and generate the text transcript for the individual slides, the additional prompt further causing the LLM to analyze the images, the text, and the presentation notes for individual slides to determine an order in which the slide are presented during playback of the presentation.

8. A computing system for enabling a presentation application to utilize a large language model to present the contents of a presentation file using a vocal output and slide navigation control data, the computing system comprising:
one or more processing units; and
a computer-readable storage medium having encoded thereon computer-executable instructions to cause the one or more processing units to:
cause the presentation application to generate a query comprising at least one of images and text within the presentation file and speaker notes,
cause the presentation application to generate a prompt for causing the large language model to:
generate a text transcript describing at least one of the images and the text within the presentation file and the speaker notes,
generate the slide navigation control data for controlling the display of individual slides within individual time periods; dep: time and order
communicate of the query to the large language model causing the large language model to generate an LLM output comprising the text transcript describing at least one of the images and the text within the presentation file and the speaker notes, the query further causing the large language model to generate slide navigation control data for controlling the display of individual slides within the individual time periods that are allocated for individual slides;
receiving the LLM output comprising the text transcript and the slide navigation control data;
using the LLM output to cause a text-to-speech to generate an audio output having a speech output of the contents of the text transcript;
using the slide navigation control data of the LLM output to cause the presentation application to display the slides of the presentation file according to the individual time periods allocated for individual slides while generating the vocal output using content from the text transcript.

9. The computing system of claim 8, wherein the query includes the entire presentation file, wherein the prompt causes the LLM to configure the text transcript to include a description of multiple sections of the presentation file,
wherein the prompt causes the LLM to configure the navigation control data to allocate individual time periods for multiple slides, and
wherein the display the slides of the presentation file is based on the individual time periods for the multiple slides.

10. The computing system of claim 8, wherein the query includes
an additional prompt that cause the LLM to determine a first set of time periods for restricting communication of audio streams that includes a vocal input from one or more users associated with one or more computing devices participating in an online meeting, wherein the restriction during the first set of time periods prevents audio streams or text generated from the audio streams from being communicated as an input to the LLM and the restriction prevents audio streams from being communicated between the computing devices participating in the online meeting during the first set of time periods,
the additional prompt that causes the LLM to determine a second set of time periods for allowing communication of audio streams that includes the vocal input from one or more users associated with one or more computing devices participating in an online meeting, wherein the permissions allowing the audio streams or the text generated from the audio streams to be communicated as the input to the LLM and the permissions allowing the audio streams to be communicated between the computing devices participating in the online meeting during the second set of time periods, wherein the method further comprises
restricting, during the first set of time periods, communication of audio streams from the one or more computing devices to prevent the audio streams or text generated from the audio streams from being communicated as the input to the LLM;
restricting, during the first set of time periods, communication of audio streams between the computing devices;
allowing, during the second set of time periods, communication of audio streams from the one or more computing devices as the input to the LLM; and
allowing, during the second set of time periods, the audio streams to be communicated between the computing devices participating in the online meeting.

11. The computing system of claim 8, wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises: generating a second query that causes the LLM to generate additional text transcript that responds to the vocal input.

12. The computing system of claim 8, wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises:
generating a second query that includes text that is transcribed from the vocal input, and an additional prompt that causes the LLM to generate a second instance of the slide navigation control data for causing a display of a second slide or a second group of slides that are selected based on the vocal input.

13. The computing system of claim 8, wherein the instructions further cause the one or more processing units to:
communicate a recording of a presentation with transcripts of the recorded presentation, and a training presentation file having slides used for the recorded presentation as an input to the LLM;
generate additional queries parameters for causing the LLM to fine-tune weights that enable the LLM to generate an output transcript having at least one of a language style that emulates the training presentation file, wherein the additional queries parameters further cause the LLM to fine-tune the weights that enable the LLM to generate the slide navigation data that emulates timing of slide transitions performed in the training presentation file; and
using the fine-tuned weights to generate subsequent text transcripts and subsequent instances of slide navigation control data based on subsequent presentation files received by the LLM.

14. The computing system of claim 8, wherein the instructions further cause the one or more processing units to: parse the presentation file into a plurality of components including images, text associated with the images, and presentation notes associated with the images, wherein query further comprises additional prompt that causes the LLM to associate the images, the text, and the presentation notes for individual slides and generate the text transcript for the individual slides, the additional prompt further causing the LLM to analyze the images, the text, and the presentation notes for individual slides to determine an order in which the slide are presented during playback of the presentation.

15. A computer-readable storage medium having encoded thereon computer-executable instructions for enabling a presentation application to utilize a large language model to present the contents of a presentation file using a vocal output and slide navigation control data, the computer-executable instructions configured to cause one or more processing units of a computing system to:
cause the presentation application to generate a query comprising at least one of images and text within the presentation file and speaker notes,
cause the presentation application to generate a prompt for causing the large language model to:
generate a text transcript describing at least one of the images and the text within the presentation file and the speaker notes,
generate the slide navigation control data for controlling the display of individual slides within individual time periods; dep: time and order
communicate of the query to the large language model causing the large language model to generate an LLM output comprising the text transcript describing at least one of the images and the text within the presentation file and the speaker notes, the query further causing the large language model to generate slide navigation control data for controlling the display of individual slides within the individual time periods that are allocated for individual slides;
receiving the LLM output comprising the text transcript and the slide navigation control data;
using the LLM output to cause a text-to-speech to generate an audio output having a speech output of the contents of the text transcript;
using the slide navigation control data of the LLM output to cause the presentation application to display the slides of the presentation file according to the individual time periods allocated for individual slides while generating the vocal output using content from the text transcript.

16. The computer-readable storage medium of claim 15, wherein the query includes the entire presentation file, wherein the prompt causes the LLM to configure the text transcript to include a description of multiple sections of the presentation file,
wherein the prompt causes the LLM to configure the navigation control data to allocate individual time periods for multiple slides, and
wherein the display the slides of the presentation file is based on the individual time periods for the multiple slides.

17. The computer-readable storage medium of claim 15, wherein the query includes
additional prompt that causes the LLM to determine a first set of time periods for restricting communication of audio streams that includes a vocal input from one or more users associated with one or more computing devices participating in an online meeting, wherein the restriction during the first set of time periods prevents audio streams or text generated from the audio streams from being communicated as an input to the LLM and the restriction prevents audio streams from being communicated between the computing devices participating in the online meeting during the first set of time periods,
the additional prompt that causes the LLM to determine a second set of time periods for allowing communication of audio streams that includes the vocal input from one or more users associated with one or more computing devices participating in an online meeting, wherein the permissions allowing the audio streams or the text generated from the audio streams to be communicated as the input to the LLM and the permissions allowing the audio streams to be communicated between the computing devices participating in the online meeting during the second set of time periods, wherein the method further comprises
restricting, during the first set of time periods, communication of audio streams from the one or more computing devices to prevent the audio streams or text generated from the audio streams from being communicated as the input to the LLM;
restricting, during the first set of time periods, communication of audio streams between the computing devices;
allowing, during the second set of time periods, communication of audio streams from the one or more computing devices as the input to the LLM; and
allowing, during the second set of time periods, the audio streams to be communicated between the computing devices participating in the online meeting.

18. The computer-readable storage medium of claim 15, wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises: generating a second query that causes the LLM to generate additional text transcript that responds to the vocal input.

19. The computer-readable storage medium of claim 15, wherein the query includes an individual slide or a select group of slides of the presentation file,
wherein the prompt causes the LLM to configure the text transcript to include a description of an individual slide or a select group of slides of the presentation file, wherein the LLM further configures the text transcript to prompt one or more recipients of the vocal output to provide a vocal input,
wherein the prompt causes the LLM to configure the navigation control data to allocate an individual time period for the individual slide or the select group of slides, wherein the display the slides of the presentation file that is based on the individual time period for the individual slide or the select group of slides, wherein the method further comprises:
generating a second query that includes text that is transcribed from the vocal input, and generating a second prompt for causing the LLM to generate a second instance of the slide navigation control data for causing a display of a second slide or a second group of slides that are selected based on the vocal input.

20. The computer-readable storage medium of claim 15, wherein the instructions further cause the one or more processing units to:
communicate a recording of a presentation with transcripts of the recorded presentation, and a training presentation file having slides used for the recorded presentation as an input to the LLM;
generate additional queries parameters for causing the LLM to fine-tune weights that enable the LLM to generate an output transcript having at least one of a language style that emulates the training presentation file, wherein the additional queries parameters further cause the LLM to fine-tune the weights that enable the LLM to generate the slide navigation data that emulates timing of slide transitions performed in the training presentation file; and
using the fine-tuned weights to generate subsequent text transcripts and subsequent instances of slide navigation control data based on subsequent presentation files received by the LLM.
